(19) United States
(12) Patent Application Publication
(10) Pub. No.: US 2018/0349580 A1
(43) Pub. Date: Dec. 6, 2018

(54) INFORMATION PROCESSING METHOD AND DEVICE, AND ELECTRONIC EQUIPMENT

(71) Applicant: BEIJING KINGSOFT INTERNET SECURITY SOFTWAR CO., LTD., Beijing (CN)

(72) Inventors: Zhongyi PENG, Beijing (CN); Wenyuan JI, Beijing (CN)

(21) Appl. No.: 15/779,128

(22) PCT Filed: Nov. 23, 2016
(86) PCT No.: PCT/CN2016/106854

§ 371 Date: May 25, 2018

(30) Foreign Application Priority Data
Nov. 27, 2015 (CN) 201510850017.0

(51) Int. Cl. G06F 21/31; H04L 29/06; G06F 17/24

(52) U.S. Cl. CPC G06F 21/31; H04L 63/083; G06F 3/04842; G06F 17/243; H04L 63/102

(57) ABSTRACT

Disclosed are information processing method and device, and electronic equipment. The method comprises: determining whether a current web page contains a user identity authentication area; if so, determining whether user identity authentication is to be performed through a quick authentication manner; if so, obtaining a quick authentication password input by a user; determining whether the quick authentication password input by the user is a quick authentication password of any user identity information corresponding to the current web page stored in a preset information list; if so, obtaining, from user identity information corresponding to the current web page stored in the preset information list, the user identity information corresponding to the quick authentication password input by the user; and sending a user identity authentication request to a server according to the obtained user identity information so as to cause the server to perform user identity authentication according to the obtained information.

The present application claims the priority to a Chinese patent application No. 201510850017.0, filed with the State Intellectual Property Office of the People's Republic of China on Nov. 27, 2015 and entitled “Information Processing Method and Device, and Electronic Equipment”, which is incorporated herein by reference in its entirety.

### TECHNICAL FIELD

The present application relates to a technical field of computer software, and in particular to a method, an apparatus for processing information, and an electronic equipment.

### BACKGROUND

In recent years, with the rapid development of hardware technology, the performance of terminals used by users has become more and more powerful. Therefore, more and more users access web pages and other information through the terminals they use. However, in actual applications, many websites require the user to first register a corresponding account, and the user can access various web pages of the website only after he/she has successfully performed identity authentication through the registered account.

Specifically, when a user accesses a website, information such as an account number and a password is required to be input in the user identity information authentication area of an application or a web page, and then a browser or an application having a browser function sends a user identity authentication request to a server according to the information such as the account number, password input by the user, and the server performs the user identity authentication after receiving the request.

Although the user identity authentication can be successfully implemented through the above manner, in actual applications, due to websites have different registration requirements, the information such as the account number and the password registered by the user may be different. Therefore, the user needs to remember a plurality of different account numbers, passwords or the like. With the increase in the number of websites accessed by the user, the account numbers and passwords that the user needs to remember are also gradually increased. As a result, the user is under an increasing pressure. In addition, each time the user accesses a website, he/she needs to input the account number and the password, which is cumbersome and inconvenient for the user to access various websites, thus causing a poor user experience.

### SUMMARY

Embodiments of the present application disclose a method, an apparatus for processing information, and an electronic equipment, so as to simplify an operation flow, facilitate users to access web page information of each website, and improve the user experience.

To achieve the above object, an embodiment of the present application discloses a method for processing information. The method includes:

determining whether a current web page contains a user identity authentication area;

if so, determining whether user identity authentication is to be performed through a quick authentication manner;

if the user identity authentication is to be performed through a quick authentication manner, obtaining a quick authentication password input by a user;

determining whether the quick authentication password input by the user is a quick authentication password of any user identity information corresponding to the current web page stored in a preset information list; wherein the preset information list is used to store user identity information corresponding to a web page containing a user identity authentication area, and quick authentication passwords corresponding to respective pieces of user identity information;

if the quick authentication password input by the user is a quick authentication password of any user identity information corresponding to the current web page, obtaining, from user identity information corresponding to the current web page stored in the preset information list, the user identity information corresponding to the quick authentication password input by the user;

sending a user identity authentication request to a server according to the obtained user identity information, so as to cause the server to perform user identity authentication according to the obtained user identity information.

In a specific implementation of the present application, determining whether user identity authentication is to be performed through a quick authentication method comprises:

determining whether the preset information list contains user identity information corresponding to the current web page, if not, it is determined that the user identity authentication is not to be performed through a quick authentication manner.

In a specific implementation of the present application, determining whether user identity authentication is to be performed through a quick authentication manner comprises:

determining whether the preset information list contains user identity information corresponding to the current web page;

if so, displaying selection information for the quick authentication manner;

determining whether the user identity authentication is to be performed through a quick authentication manner according to the user's selection operation for the selection information.

In a specific implementation of the present application, obtaining the user identity information, corresponding to the quick authentication password input by the user, from user identity information corresponding to the current web page stored in the preset information list comprises:

determining user identity information corresponding to the current web page stored in the preset information list;

obtaining, from the determined user identity information, the number of pieces of user identity information whose quick authentication password is consistent with the quick authentication password input by the user;

determining whether the obtained number is greater than 1;

if so, obtaining the user identity information corresponding to the quick authentication password input by the user according to the user's selection operation for the determined user identity information.

In a specific implementation of the present application, when it is determined that user identity authentication is not to be performed through a quick authentication manner, the method further comprises:

obtaining user identity information Inf_{UID} input by the user in the user identity authentication area of the current web page;

sending a user identity authentication request to a server according to the user identity information Inf_{UID};

when the user identity authentication is determined to be successful, determining whether a correspondence between the current web page and the user identity information Inf_{UID} is to be stored in the preset information list;

if so, storing the correspondence between the current web page and the user identity information Inf_{UID} in a preset information list according to a preset information storage rule.

In a specific implementation of the present application, storing the correspondence between the current web page and the user identity information Inf_{UID} in a preset information list according to a preset information storage rule comprises:

determining whether the preset information list contains a quick authentication password;

if so, storing the correspondence between the current web page and the user identity information Inf_{UID} in the preset information list;

if not, obtaining a quick authentication password input by the user, and determining the obtained quick authentication password as a quick authentication password corresponding to the user identity information Inf_{UID}, and storing the correspondence between the current web page and the user identity information Inf_{UID} and the quick authentication password corresponding to the user identity information Inf_{UID} in the preset information list.

In a specific implementation of the present application, before storing the correspondence between the current web page and the user identity information Inf_{UID} in the preset information list, the method further comprises:

obtaining an identity authentication password input by the user;

determining whether the identity authentication password is consistent with a quick authentication password existing in the preset information list;

if so, storing the correspondence between the current web page and the user identity information Inf_{UID} in the preset information list.

In a specific implementation of the present application, storing the correspondence between the current web page and the user identity information Inf_{UID} in a preset information list according to a preset information storage rule comprises:

obtaining a category to which the current web page belongs;

determining whether the preset information list contains a category quick authentication password corresponding to the category;

if so, determining the category quick authentication password as a quick authentication password corresponding to the user identity information Inf_{UID};

if not, obtaining a category quick authentication password input by the user, and determining the obtained category quick authentication password as a quick authentication password corresponding to the user identity information Inf_{UID}, and storing the correspondence between the current web page and the user identity information Inf_{UID} and the quick authentication password corresponding to the user identity information Inf_{UID} in the preset information list.

In a specific implementation of the present application, determining whether the preset information list contains a category quick authentication password corresponding to the category comprises:

obtaining an identity authentication password input by the user;

determining whether the identity authentication password is consistent with a category quick authentication password stored in the preset information list according to the category;

if so, determining that there is a category quick authentication password corresponding to the category existing in the preset information list.

In a specific implementation of the present application, storing the correspondence between the current web page and the user identity information Inf_{UID} in a preset information list according to a preset information storage rule comprises:

obtaining a quick authentication password input by the user.

determining the quick authentication password input by the user as a quick authentication password corresponding to the user identity information Inf_{UID};

storing the correspondence between the current web page and the user identity information Inf_{UID} and the quick authentication password corresponding to the user identity information Inf_{UID} in the preset information list.

In a specific implementation of the present application, obtaining user identity information Inf_{UID} input by the user in the user identity authentication area of the current web page comprises:

calling a preset function to obtain each piece of character information input by the user in the user identity authentication area of the current web page, and obtain the user identity information Inf_{UID} according to the obtained character information; or

obtaining the user identity information Inf_{UID} according to a preset character recognition algorithm, after it is determined that the user has finished inputting the user identity information Inf_{UID} in the user identity authentication area of the current web page.

To achieve the above object, an embodiment of the present application discloses an apparatus for processing information. The apparatus includes:

a web page determination module, configured to determine whether a current web page contains a user identity authentication area;

an authentication manner determination module, configured to determine whether the user identity authentication is to be performed through a quick authentication manner when the determination result of the web page determination module is YES;

an authentication password obtaining module, configured to obtain a quick authentication password input by the user when the determination result of the authentication manner determination module is YES;

an authentication password determination module, configured to determine whether the quick authentication password input by the user is a quick authentication password of any user identity information corresponding to the current web page stored in a preset information list; wherein the preset information list is used to store user identity information corresponding to a web page containing a user identity authentication area, and quick authentication passwords corresponding to respective pieces of user identity information;

a first user identity information obtaining module, configured to obtain, from user identity information corresponding to the current web page stored in the preset information list, the user identity information corresponding to the quick authentication password input by the user when the determination result of the authentication password determination module is YES;

a first authentication request sending module, configured to send a user identity authentication request to a server according the obtained user identity information, so as to cause the server to perform user identity authentication according to the obtained user identity information.

In a specific implementation of the present application, the authentication manner determination module is configured to determine whether the preset information list contains user identity information corresponding to the current web page, if not, it is determined that the user identity authentication is not to be performed through a quick authentication manner.

In a specific implementation of the present application, the authentication manner determination module comprises:

a user identity information determination submodule, configured to determine whether the preset information list contains user identity information corresponding to the current web page;

a selection information displaying submodule, configured to display selection information for the quick authentication manner when the determination result of the user identity information determination submodule is YES;

a authentication manner determination submodule, configured to determine whether the user identity authentication is to be performed through a quick authentication manner according to the user's selection operation for the selection information.

In a specific implementation of the present application, the first user identity information obtaining module comprises:

a user identity information determination submodule, configured to determine user identity information corresponding to the current web page stored in the preset information list;

an information quantity obtaining submodule, configure to determine, from the determined user identity information, the number of pieces of user identity information in which a quick authentication password is consistent with the quick authentication password input by the user;

an information quantity determination submodule, configured to determine whether the obtained number is greater than 1;

a user identity information obtaining submodule, configured to obtain the user identity information corresponding to the quick authentication password input by the user according to the user's selection operation for the determined user identity information, when the determination result of the information quantity determination submodule is YES.

In a specific implementation of the present application, the apparatus for processing information further comprises:

a second user identity information obtaining module, configured to obtain the user identity information Inf_{UID} input by the user in the user identity authentication area of the current web page, when it is determined that the user identity authentication is not to be performed through a quick authentication manner;

a second authentication request sending module, configured to send a user identity authentication request to a server according to the user identity information Inf_{UID};

a correspondence storage determination module, configured to, when the user identity authentication is determined to be successful, determine whether a correspondence between the current web page and the user identity information Inf_{UID} is to be stored in the preset information list.

a correspondence storage module, configured to store the correspondence between the current web page and the user identity information Inf_{UID} in the preset information list according to a preset information storage rule, when the determination result of the correspondence storage determination module is YES.

In a specific implementation of the present application, the correspondence storage module includes:

a first authentication password determination submodule, configured to determine whether the preset information list contains a quick authentication password;

a first correspondence storage module, configured to store the correspondence between the current web page and the user identity information Inf_{UID} in the preset information list, when the determination result of the first authentication password determination submodule is YES;

a second correspondence storage submodule, configured to, when the determination result of the first authentication password determination submodule is NO, obtain a quick authentication password input by the user, and determine the obtained quick authentication password as a quick authentication password corresponding to the user identity information Inf_{UID}, and store the correspondence between the current web page and the user identity information Inf_{UID} and the quick authentication password corresponding to the user identity information Inf_{UID} in the preset information list.

In a specific implementation of the present application, the correspondence storage module further includes:

a verification password obtaining submodule, configured to obtain an identity authentication password input by the user before the first correspondence storage submodule stores the correspondence;

a verification password determination submodule, configured to determine whether the identity authentication password is consistent with a quick authentication password existing in the preset information list, if so, the first correspondence storage submodule is triggered to store the correspondence.

In a specific implementation of the present application, the correspondence storage module includes:

a category obtaining sub-module, configured to obtain a category to which the current web page belongs;

a second authentication password determination submodule, configured to determine whether the preset information list contains a category quick authentication password corresponding to the category;

a third correspondence storage submodule, configured to determine the category quick authentication password as a quick authentication password corresponding to the user identity information Inf_{UID}, when the determination result of the second authentication password determination submodule is YES;

a fourth correspondence storage submodule, configured to, when the determination result of the second authentication password determination submodule is NO, obtain a category quick authentication password input by the user, and determine the obtained category quick authentication password as a quick authentication password corresponding to the user identity information Inf_{UID}, and store the correspondence between the current web page and the user identity information Inf_{UID} and the quick authentication password corresponding to the user identity information Inf_{UID} in the preset information list.

In a specific implementation of the present application, the second authentication password determination submodule comprises:

a verification password obtaining unit, configured to obtain an identity authentication password input by the user;

a verification password determination unit, configured to determine whether the identity authentication password is consistent with a category quick authentication password stored in the preset information list according to the category; if so, it is determined that the preset information list contains a category quick authentication password corresponding to the category.

In a specific implementation of the present application, the correspondence storage module includes:

a verification password obtaining submodule, configured to obtain a quick authentication password input by the user;

an authentication password determination submodule, configured to determine the quick authentication password input by the user as a quick authentication password corresponding to the user identity information Inf_{UID};

a fifth correspondence storage submodule, configured to store the correspondence between the current web page and the user identity information Inf_{UID} and the quick authentication password corresponding to the user identity information Inf_{UID} in the preset information list.

In a specific implementation of the present application, the second user identity information obtaining module is configured to:

call a preset function to obtain each piece of character information input by the user in the user identity authentication area of the current web page, and obtain the user identity information Inf_{UID} according to the obtained character information; or

obtain the user identity information Inf_{UID} according to a preset character recognition algorithm, after it is determined that the user has finished inputting the user identity information Inf_{UID} in the user identity authentication area of the current web page.

To achieve the above object, an embodiment of the present application discloses an electronic equipment, including: a housing, a processor, a memory, a circuit board, and a power circuit, wherein the circuit board is disposed inside the space enclosed by the housing, the processor and the memory are disposed on the circuit board; the power circuit is used to supply power to each circuit or device of the electronic equipment; the memory is used to store an executable program code; the processor reads the executable program code stored in the memory to execute a program corresponding to the executable program code for performing the following steps:

determining whether a current web page contains a user identity authentication area;

if so, determining whether user identity authentication is to be performed through a quick authentication manner;

if the user identity authentication is to be performed through a quick authentication manner, obtaining a quick authentication password input by a user;

determining whether the quick authentication password input by the user is a quick authentication password of any user identity information corresponding to the current web page stored in a preset information list; wherein the preset information list is used to store user identity information corresponding to a web page containing a user identity authentication area, and quick authentication passwords corresponding to respective pieces of user identity information;

if the quick authentication password input by the user is a quick authentication password of any user identity information corresponding to the current web page, obtaining, from user identity information corresponding to the current web page stored in the preset information list, the user identity information corresponding to the quick authentication password input by the user;

sending a user identity authentication request to a server according to the obtained user identity information, so as to cause the server to perform user identity authentication according to the obtained user identity information.

To achieve the above object, an embodiment of the present application discloses an application program, which is used to perform the method for processing information according to the above embodiments when being executed.

To achieve the above object, an embodiment of the present application discloses a storage medium, which is used to store an executable code, and the executable code is used to perform the method for processing information according to the above embodiments.

From the foregoing, it can be seen that in the solutions provided in this embodiment, when the current web page contains a user identity authentication area and it is determined that user identity authentication is to be performed through a quick authentication manner, a quick authentication password input by the user is obtained; and when it is determined that the obtained quick authentication password is a quick authentication password of any user identity information corresponding to the current web page stored in the preset information list, the user input information corresponding to the quick authentication password input by the user is obtained from user identity information corresponding to the current web page stored in the preset information list; then a user identity authentication request is sent to the server according to the obtained user identity information, so that the server performs user identity authentication according to the obtained user identity information. Compared with the prior art, after storing various user identity information in a preset information list, the user only need to remember and input a quick authentication password to implement user identity authentication, which simplifies the operation flow and facilitates the user's access to various websites, thereby improving the user experience.

### BRIEF DESCRIPTION OF THE DRAWINGS

In order to more clearly illustrate the embodiments of the present application and the technical solutions of the prior art, the drawings that need to be used in the embodiments and the prior art will be briefly described below. Obviously, the drawings in the following description are only some embodiments of the present application; those skilled in the art can also obtain other drawings based on these drawings without any creative efforts.

FIG. 1 is a schematic flow chart of a first method for processing information according to an embodiment of the present application;

FIG. 2a is a schematic diagram of a first interface according to an embodiment of the present application;

FIG. 2b is a schematic diagram of a second interface according to an embodiment of the present application;

FIG. 3 is a schematic flow chart of a second method for processing information according to an embodiment of the present application;

FIG. 4a is a schematic diagram of a third interface according to an embodiment of the present application;

FIG. 4b is a schematic diagram of a fourth interface according to an embodiment of the present application;

FIG. 5 is a schematic structural diagram of a first apparatus for processing information according to an embodiment of the present application;

FIG. 6 is a schematic structural diagram of a second apparatus for processing information according to an embodiment of the present application;

FIG. 7 is a schematic structural diagram of an electronic equipment according to an embodiment of the present application.

### DETAILED DESCRIPTION

In order to make the objectives, technical solutions, and advantages of the present application clearer and more understandable, the present application will be described in more detail below with reference to the accompanying drawings and embodiments. Obviously, the described embodiments are only some, and not all, of the embodiments of the present application. All other embodiments obtained based on the embodiments of the present application by those skilled in the art without any creative efforts fall within the protection scope of the present application.

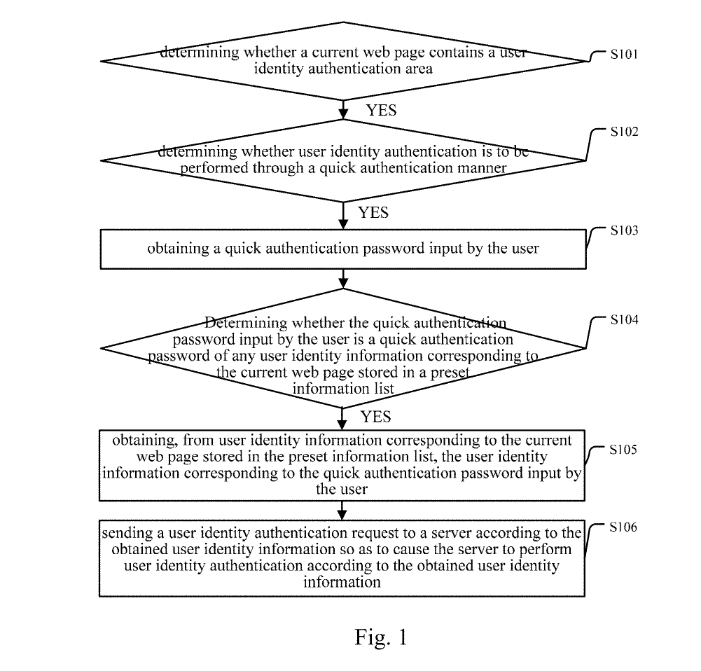

FIG. 1 is a schematic flow chart of a first method for processing information according to an embodiment of the present application, the method includes:

S101: determining whether a current web page contains a user identity authentication area, if so, performing S102.

It should be noted that the execution subject of the embodiment of the present application can be understood as: a browser or an application with a browser function.

The above user identity authentication area generally refers to an area for the user to input user identity information such as an account number and a password. The user identity authentication area may include an account input box, a password input box, a registration button, a login button, and so on, which is not limited by the present application.

Specifically, in actual applications, a plurality of ways can be used to determine whether the current web page contains a user identity authentication area.

In one case, whether the current web page contains a user identity authentication area can be determined by determining whether the source code of the current web page contains keywords such as “account number”, “password”, “registration”, and “login”.

In another case, whether the current web page contains a user identity authentication area can be determined by identifying whether the current web page contains the above keywords such as “account number” and “password” or an information input box of a preset size through a preset identification algorithm.

In another case, whether the current web page contains a user identity authentication area can be determined by determining whether the identifier of the current web page belongs to a preset web page list, wherein the preset web page list is used to store the identifier of a web page containing a user identity authentication area.

In another case, whether the current web page contains a user identity authentication area can be determined by determining whether the website information of the current web page contains preset keywords such as “login” or the like.

It should be noted that the present application is described by taking the above as an example. In actual applications, the way for determining whether the current web page contains a user identity authentication area is not limited thereto.

S102: determining whether user identity authentication is to be performed through a quick authentication manner, if so, performing S103.

Specifically, in a specific implementation of the present application, whether the user identity authentication is to be performed through a quick authentication manner can be determined by determining whether the preset information list contains the user identity information corresponding to the current web page. Specifically, if there is no user identity information corresponding to the current web page in the preset information list, it can be determined that the user identity authentication is not to be performed through the quick authentication manner.

The above preset information list is used to store user identity information corresponding to a web page containing a user identity authentication area, and quick authentication passwords corresponding to respective pieces of user identity information.

In another specific implementation of the present application, when determining whether the user identity authentication is to be performed through a quick authentication manner, it can also be determined first whether the preset information list contains the user identity information corresponding to the current web page, if so, selection information for the quick authentication manner is displayed, and whether the user identify authentication is to be performed through a quick authentication manner is determined according to the user's selection operation for the above selection information.

It can be understood that the user's selection operation can be generally divided into two types. One type indicates that the user agrees to perform the user identity authentication through the quick authentication manner, and the other type indicates that the user does not agree to perform the user identity authentication through the quick authentication manner.

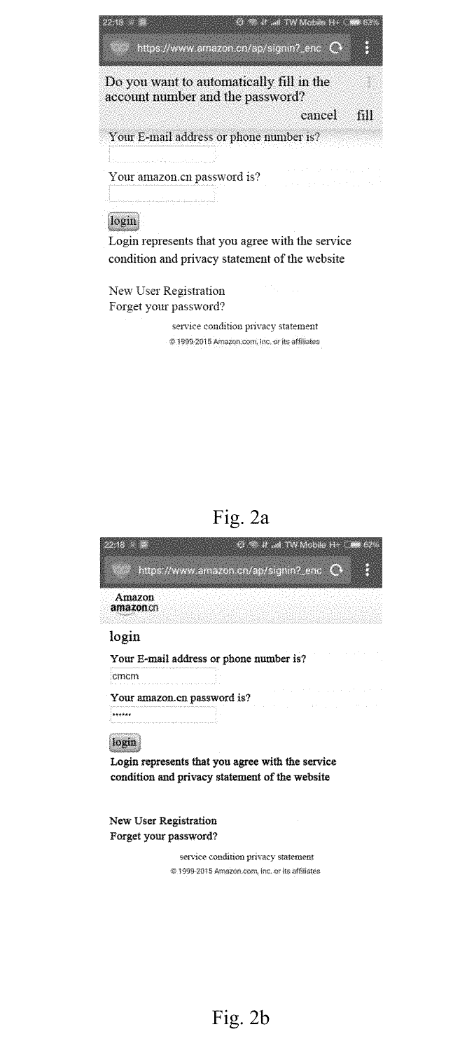

Specifically, referring to FIG. 2a, a schematic diagram of a first interface is provided. In the schematic diagram, the selection information for the quick authentication manner is displayed through a prompt message such as “Do you want to automatically fill in the account number and the password?”.

S103: obtaining a quick authentication password input by the user.

Specifically, the quick authentication password may be a numeric password, a gesture password, a graphic password, a fingerprint password, an image password, a voice password, and the like, which is not limited in this application.

S104: determining whether the quick authentication password input by the user is a quick authentication password of any user identity information corresponding to the current web page stored in the preset information list; if so, performing S105.

The above preset information list is used to store user identity information corresponding to a web page containing a user identity authentication area, and quick authentication passwords corresponding to respective pieces of user identity information.

It should be noted that quick authentication passwords corresponding to all the user identity information stored in the preset information list may be the same quick authentication password, and may also be different quick authentication passwords.

Further, user identity information of web pages belonging to one same category may correspond to one same quick authentication password;

user identity information of web pages belonging to a plurality of preset categories may correspond to one same quick authentication password;

a piece of user identity information corresponds to a quick authentication password;

pieces of user identity information of the same web page corresponds to different quick authentication passwords.

This application is only described by taking the above as an example. In actual applications, the correspondence between the user identity information and the quick authentication password is not limited thereto.

In addition, when a quick authentication password corresponding to each piece of user identity information is stored in the above preset information list, it may be that for each user identity information, a quick authentication password is stored correspondingly, or only one quick authentication password may be stored in the entire list, or only the quick authentication password corresponding to each category is stored.

S105: obtaining, from user identity information corresponding to the current web page stored in the preset information list, the user identity information corresponding to the quick authentication password input by the user.

Specifically, in the user identity information corresponding to the current web page stored in the preset information list, there may be only one piece of user identity information whose quick authentication password is the same as the quick authentication password input by the user, and there may be multiple pieces of user identity information whose quick authentication password is the same as the quick authentication password input by the user.

For the above case where there is only one piece of user identity information whose quick authentication password is the same as the quick authentication password input by the user, the user identity information whose quick authentication password is the same as and the quick authentication password input by the user can be used as user identity information corresponding to the quick authentication password input by the user.

For the above case where there are a plurality of pieces of user identification information whose quick authentication password is the same as the quick authentication password input by the user, when obtaining user identity information corresponding to the quick authentication password input by the user, first user identity information corresponding to the current web page stored in the preset information list can be determined. Then in the determined user identity information, the number of pieces of user identity information whose quick authentication password is consistent with the quick authentication password input by the user is obtained, and then it is determined whether the obtained number is greater than one. If so, user identity information corresponding to the quick authentication password input by the user is obtained according to the user's selection operation for the determined user identity information.

S106: sending a user identity authentication request to a server according the obtained user identity information so as to cause the server to perform user identity authentication according to the obtained user identity information.

Specifically, after obtaining the user identity information in S105, the user identity authentication request can be directly generated without displaying the obtained information in the user identity authentication area, and then the user identity authentication request can be sent to the server.

In addition, after obtaining the user identity information in S105, the obtained user identity information can also be displayed in the user identity authentication area, and only after it is detected that the user clicks the “login” button, the user identity authentication request is generated and then sent to the server.

Specifically, referring to FIG. 2b, a schematic diagram of a second interface is provided. The schematic diagram shows an interface that the user identity information has already filled into the user identity authentication area.

From the foregoing, it can be seen that in the solutions provided in this embodiment, when the current web page contains a user identity authentication area and it is determined that user identity authentication is to be performed through a quick authentication manner, a quick authentication password input by the user is obtained; and when it is determined that the obtained quick authentication password is a quick authentication password of any user identity information corresponding to the current web page stored in the preset information list, the user input information corresponding to the quick authentication password input by the user is obtained from user identity information corresponding to the current web page stored in the preset information list; then a user identity authentication request is sent to a server according to the obtained user identity information, so that the server performs user identity authentication according to the obtained user identity information. Compared with the prior art, after storing various user identity information in a preset information list, the user only need to remember and input a quick authentication password to implement user identity authentication, which simplifies the operation flow and facilitates the user's access to various websites, thereby improving the user experience.

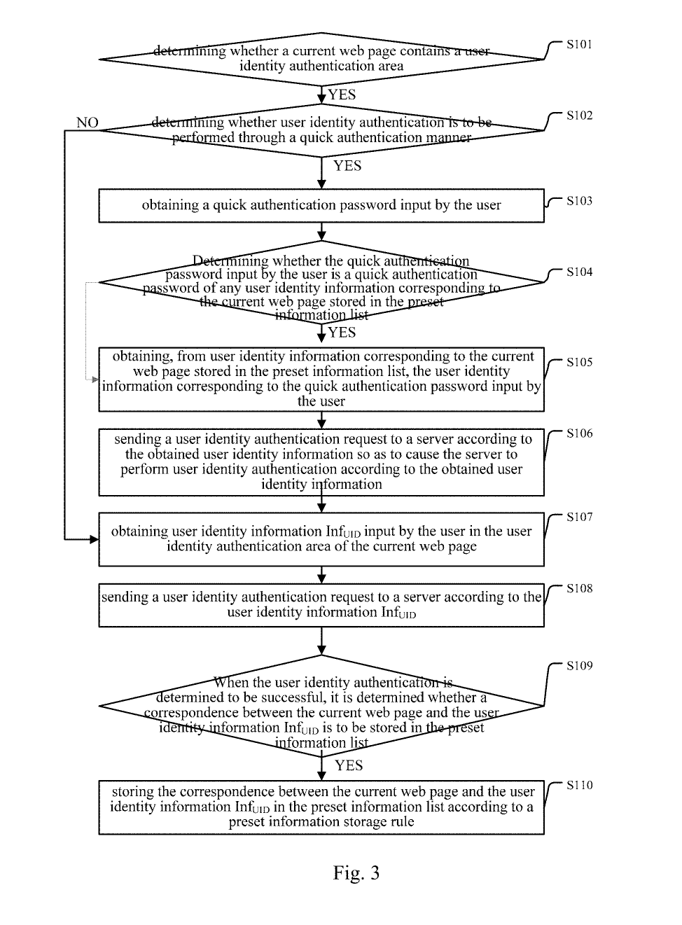

In a specific implementation of the present application, referring to FIG. 3, a schematic flowchart of a second method for processing information is provided. Compared with the foregoing embodiments, in this embodiment, when it is determined at S102 that the user identity authentication is not performed through a quick authentication manner, the method further includes:

S107: obtaining user identity information Inf_{UID} input by the user in the user identity authentication area of the current web page.

Specifically, when obtaining the user identity information Inf_{UID} input by the user in the user identity authentication area of the current web page, each piece of character information input by the user in the user identity authentication area of the current web page can be obtained by calling a preset function, and the user identity information Inf_{UID} is obtained according to the obtained character information; alternatively, after it is determined that the user has finished inputting the user identity information Inf_{UID} in the user identity authentication area of the current web page, the user identity information Inf_{UID} can be obtained according to a preset character recognition algorithm, which is not limited by the present application.

When the user identity information Inf_{UID} is obtained according to a preset character recognition algorithm, it can be understood that the character recognition is performed on the above user identity authentication area using a preset character recognition algorithm to obtain a character recognition result, and then the user identity information Inf_{UID} is obtained according to the character recognition result. For example, all the characters contained in the character recognition result are used as the user identity information Inf_{UID}, or the characters, in the character recognition result, whose confidence is higher than a preset threshold can be used as the user identity information Inf_{UID}. Of course, the user identity information Inf_{UID} can also be obtained through other ways.

S108: sending a user identity authentication request to a server according to the user identity information Inf_{UID}.

S109: when the user identity authentication is determined to be successful, it is determined whether a correspondence between the current web page and the user identity information Inf_{UID} is to be stored in the preset information list, if so, performing S110.

Specifically, the browser can display an information storage prompt message to the user, the user makes a selection based on the prompt message, and then the browser determines whether to store the correspondence between the current web page and the user identity information Inf_{UID} in the preset information list according to the user's selection operation.

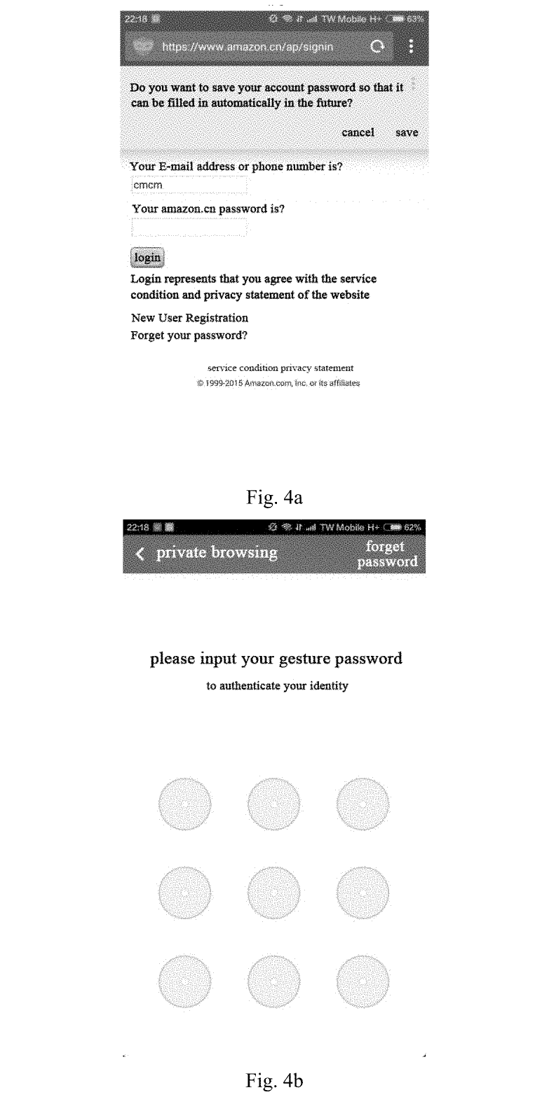

Specifically, referring to FIG. 4a, a schematic diagram of a third interface is provided, where the user is prompted with information such as “Do you want to save your account password so that it can be filled in automatically in the future?”.

S110: storing the correspondence between the current web page and the user identity information Inf_{UID} in a preset information list according to a preset information storage rule.

In an optional implementation of the present application, when the correspondence between the current web page and the user identity information Inf_{UID} is stored in a preset information list according to a preset information storage rule, first it can be determined whether the preset information list contains a quick authentication password. If so, the correspondence between the current web page and the user identity information Inf_{UID} is stored in the preset information list. If not, the quick authentication password input by the user is obtained, and the obtained quick authentication password is determined as the quick authentication password corresponding to the user identity information Inf_{UID}, and the correspondence between the current web page and the user identity information Inf_{UID} and the quick authentication password corresponding to the user identity information Inf_{UID} are stored in the preset information list.

In this optional implementation, it can be understood that the quick authentication password stored in the preset information list is a quick authentication password for each piece of user identity information in the list.

Specifically, before storing the correspondence between the current web page and the user identity information Inf_{UID} in the preset information list, an identity authentication password input by the user can also be obtained, and then determined whether the identity authentication password is consistent with a quick authentication password in the preset information list, if so, performing step S110.

The above identity authentication password is input by the user. Similar to the quick authentication password, the identity authentication password may also have multiple situations, which will not be enumerated herein. Specifically, referring to FIG. 4b, a schematic diagram of a fourth interface is provided. The interface shown in this schematic diagram is an interface for a user to input a gesture password.

In another optional implementation of the present application, when the correspondence between the current web page and the user identity information Inf_{UID} is stored in a preset information list according to a preset information storage rule, first a category to which the current web page belongs can be obtained, then it can be determined whether the preset information list contains a category quick authentication password corresponding to the above category. If so, the above category quick authentication password is determined as the quick authentication password corresponding to the user identity information Inf_{UID}. If not, the category quick authentication password input by the user is obtained, and the obtained category quick authentication password is determined as the quick authentication password corresponding to the user identity information Inf_{UID}, and the correspondence between the current web page and the user identity information Inf_{UID} and the quick authentication password corresponding to the user identity information Inf_{UID} are stored in the preset information list.

In actual applications, there are many factors that can be used to classify the category of a web page. For example,

the category of a web page can be classified according to the website corresponding to the web page, for example, web pages correspond to Sina can be classified into one category, web pages correspond to Baidu can be classified into one category and so on.

Alternatively, the category can be classified according to the type of content displayed on the web page. For example, web pages in which the displayed content is shopping information can be classified into one category (such as shopping category), and web pages in which the displayed content is email information can be classified into one category (such as email category) and so on.

It should be noted that the present application is described by taking the above as an example. In actual applications, the factors for classifying the category of a web page are not limited thereto.

Specifically, when determining whether the preset information list contains a category quick authentication password corresponding to the category, an identity authentication password input by the user can be obtained first, and then it is determined whether the identity authentication password is consistent with a category quick authentication password stored in the preset information list according to this category. If so, it is determined that the preset information list contains a category quick authentication password corresponding to the above category.

In another optional implementation of the present application, when the correspondence between the current web page and the user identity information Inf_{UID}is stored in a preset information list according to a preset information storage rule, the quick authentication password input by the user can be obtained, and the quick authentication password input by the user is determined as the quick authentication password corresponding to the user identity information Inf_{UID}, and the correspondence between the current web page and the user identity information Inf_{UID} and the quick authentication password corresponding to the user identity information Inf_{UID} are stored in the preset information list.

It should be noted that in this optional implementation, the quick authentication password input by the user may be or may not be the same as a quick authentication password of the user identity information stored in the preset information list, which is not limited by the present application.

From the foregoing, it can be seen that in the solution provided in this embodiment, when it is determined that the user identity authentication is not performed through a quick authentication manner, a user identity authentication request is sent to the server according to the user identity information input by the user; and when the user identity authentication is determined to be successful, it is determined whether the correspondence between the current web page and the user identity information Inf_{UID} is to be stored in the preset information list; if so, the correspondence between the current web page and the user identity information Inf_{UID} is stored in the preset information list according to a preset information storage rule. In this way, when the user accesses the current web page again, the current web page can be quickly accessed according to the information stored in the preset information list.

Corresponding to the above method for processing information, an embodiment of the present application further provides an apparatus for processing information.

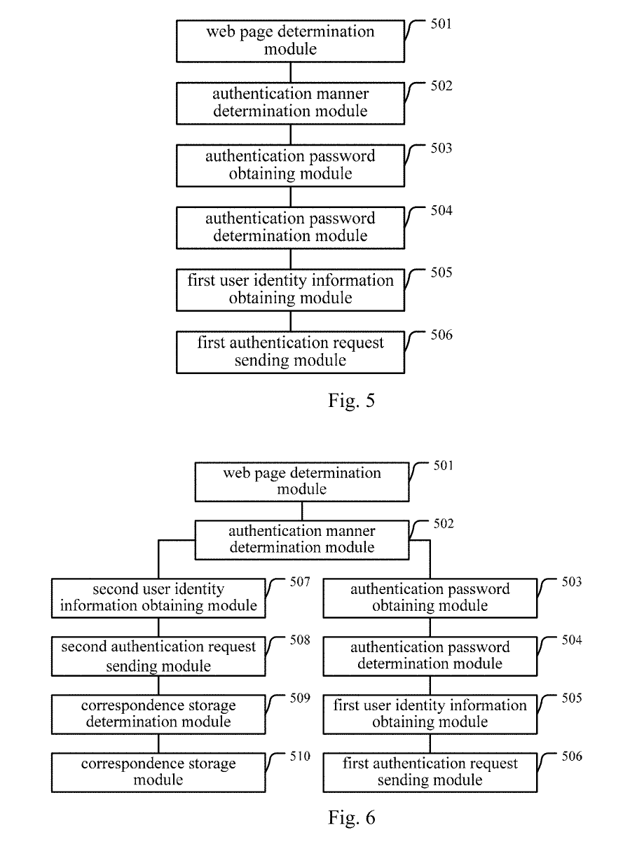

FIG. 5 is a schematic structural diagram of a first apparatus for processing information according to an embodiment of the present application, the apparatus includes:

a web page determination module 501, configured to determine whether a current web page contains a user identity authentication area;

an authentication manner determination module 502, configured to determine whether the user identity authentication is to be performed through a quick authentication manner when the determination result of the web page determination module 501 is YES;

an authentication password obtaining module 503, configured to obtain a quick authentication password input by the user when the determination result of the authentication manner determination module 502 is YES;

an authentication password determination module 504, configured to determine whether the quick authentication password input by the user is a quick authentication password of any user identity information corresponding to the current web page stored in a preset information list; wherein the preset information list is used to store user identity information corresponding to a web page containing a user identity authentication area, and quick authentication passwords corresponding to respective pieces of user identity information;

a first user identity information obtaining module 505, configured to obtain, from user identity information corresponding to the current web page stored in the preset information list, the user identity information corresponding to the quick authentication password input by the user, when the determination result of the authentication password determination module 504 is YES;

a first authentication request sending module 506, configured to send a user identity authentication request to a server according the obtained user identity information, so as to cause the server to perform user identity authentication according to the obtained user identity information.

Specifically, the authentication manner determination module 502 can be specifically configured to determine whether the preset information list contains the user identity information corresponding to the current web page, if not, it is determined that the user identity authentication is not to be performed through a quick authentication manner.

Specifically, the authentication manner determination module 502 can include:

a user identity information determination submodule, configured to determine whether the preset information list contains the user identity information corresponding to the current web page;

a selection information displaying submodule, configured to display selection information for the quick authentication manner when the determination result of the user identity information determination submodule is YES;

a authentication manner determination submodule, configured to determine whether the user identity authentication is to be performed through a quick authentication manner according to the user's selection operation for the selection information.

Specifically, the first user identity information obtaining module 505 can include:

a user identity information determination submodule, configured to determine the user identity information corresponding to the current web page stored in the preset information list;

an information quantity obtaining submodule, configure to configure to obtain, from the determined user identity information, the number of pieces of user identity information whose quick authentication password is consistent with the quick authentication password input by the user;

an information quantity determination submodule, configured to determine whether the obtained number is greater than 1;

a user identity information obtaining submodule, configured to obtain the user identity corresponding to the quick authentication password input by the user according to the user's selection operation for the determined user identity information, when the determination result of the information quantity determination submodule is YES.

From the foregoing, it can be seen that in the solutions provided in this embodiment, when the current web page contains a user identity authentication area and it is determined that the user identity authentication is to be performed through a quick authentication manner, a quick authentication password input by the user is obtained; and when it is determined that the obtained quick authentication password is a quick authentication password of any user identity information corresponding to the current web page stored in the preset information list, the user input information corresponding to the quick authentication password input by the user is obtained from user identity information corresponding to the current web page stored in the preset information list; then a user identity authentication request is sent to a server according to the obtained user identity information, so that the server performs user identity authentication according to the obtained user identity information. Compared with the prior art, after storing various user identity information in a preset information list, the user only need to remember and input a quick authentication password to implement user identity authentication, which simplifies the operation flow and facilitates the user's access to various websites, thereby improving the user experience.

In a specific implementation of the present application, referring to FIG. 6, a schematic flowchart of a second apparatus for processing information is provided. Compared with the foregoing embodiments, in this embodiment, the above apparatus for processing information further includes:

a second user identity information obtaining module 507, configured to obtain the user identity information Inf_{UID} input by the user in the user identity authentication area of the current web page, when it is determined that the user identity authentication is not to be performed through a quick authentication manner;

a second authentication request sending module 508, configured to send a user identity authentication request to a server according to the user identity information Inf_{UID};

a correspondence storage determination module 509, configured to, when the user identity authentication is determined to be successful, determine whether a correspondence between the current web page and the user identity information Inf_{UID} is to be stored in the preset information list.

a correspondence storage module 510, configured to store the correspondence between the current web page and the user identity information Inf_{UID} in the preset information list according to a preset information storage rule, when the determination result of the correspondence storage determination module 509 is YES.

In an optional implementation of the present application, the correspondence storage determination module 509 can include:

a first authentication password determination submodule, configured to determine whether the preset information list contains a quick authentication password;

a first correspondence storage module, configured to store the correspondence between the current web page and the user identity information Inf_{UID} in the preset information list, when the determination result of the first authentication password determination submodule is YES;

a second correspondence storage submodule, configured to, when the determination result of the first authentication password determination submodule is NO, obtain a quick authentication password input by the user, and determine the obtained quick authentication password as a quick authentication password corresponding to the user identity information Inf_{UID}, and store the correspondence between the current web page and the user identity information Inf_{UID} and the quick authentication password corresponding to the user identity information Inf_{UID} in the preset information list.

Specifically, the correspondence storage module 509 can further include:

a verification password obtaining submodule, configured to obtain an identity authentication password input by the user before the first correspondence storage submodule stores the correspondence;

a verification password determination submodule, configured to determine whether the identity authentication password is consistent with a quick authentication password existing in the preset information list, if so, the first correspondence storage submodule is triggered to store the correspondence.

In another optional implementation of the present application, the correspondence storage determination module 509 can include:

a category obtaining sub-module, configured to obtain a category to which the current web page belongs;

a second authentication password determination submodule, configured to determine whether the preset information list contains a category quick authentication password corresponding to the category;

a third correspondence storage submodule, configured to determine the category quick authentication password as a quick authentication password corresponding to the user identity information Inf_{UID}, when the determination result of the second authentication password determination submodule is YES;

a fourth correspondence storage submodule, configured to, when the determination result of the second authentication password determination submodule is NO, obtain a category quick authentication password input by the user, and determine the obtained category quick authentication password as a quick authentication password corresponding to the user identity information Inf_{UID}, and store the correspondence between the current web page and the user identity information Inf_{UID} and the quick authentication password corresponding to the user identity information Inf_{UID} in the preset information list.

Specifically, the second authentication password determination submodule can include:

a verification password obtaining unit, configured to obtain an identity authentication password input by the user;

a verification password determination unit, configured to determine whether the identity authentication password is consistent with a category quick authentication password stored in the preset information list according to the category; if so, it is determined that the preset information list contains the category quick authentication password corresponding to the category.

In another optional implementation of the present application, the correspondence storage determination module 509 can include:

a verification password obtaining module, configured to obtain a quick authentication password input by the user;

an authentication password determination submodule, configured to determine the quick authentication password input by the user as a quick authentication password corresponding to the user identity information Inf_{UID};

a fifth correspondence storage submodule, configured to store the correspondence between the current web page and the user identity information Inf_{UID} and the quick authentication password corresponding to the user identity information Inf_{UID} in the preset information list.

Specifically, the second user identity information obtaining module 507 can be configured to:

call a preset function to obtain each piece of character information input by the user in the user identity authentication area of the current web page, and obtain the user identity information Inf_{UID} according to the obtained character information; or

obtain the user identity information Inf_{UID} according to a preset character recognition algorithm, after it is determined that the user has finished inputting the user identity information Inf_{UID} in the user identity authentication area of the current web page.

From the foregoing, it can be seen that in the solution provided in this embodiment, when it is determined that the user identity authentication is not performed through a quick authentication manner, a user identity authentication request is sent to a server according to the user identity information input by the user; and when the user identity authentication is determined to be successful, it is determined whether the correspondence between the current web page and the user identity information Inf_{UID} is to be stored in the preset information list; if so, the correspondence between the current web page and the user identity information Inf_{UID} is stored in the preset information list according to a preset information storage rule. In this way, when the user accesses the current web page again, the current web page can be quickly accessed according to the information stored in the preset information list.

Corresponding to the above method for processing information and the apparatus for processing information, an embodiment of the present application further provides an electronic device.

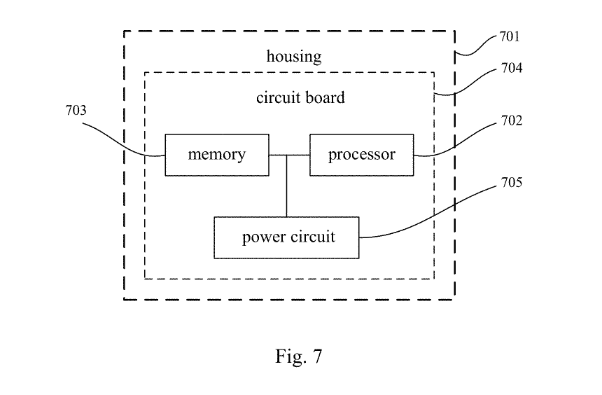

FIG. 7 is a schematic structural diagram of an electronic equipment according to an embodiment of the present application. The electronic equipment includes: a housing 701, a processor 702, a memory 703, a circuit board 704, and a power circuit 705. The circuit board 704 is disposed inside the space enclosed by the housing 701, the processor 702 and the memory 703 are disposed on the circuit board 704; the power circuit 705 is used to supply power to each circuit or device of the electronic equipment; the memory 703 is used to store an executable program code; the processor 702 reads the executable program code stored in the memory 703 to execute a program corresponding to the executable program code for performing the following steps:

determining whether a current web page contains a user identity authentication area;

if so, determining whether user identity authentication is to be performed through a quick authentication manner;

if the user identity authentication is to be performed through a quick authentication manner, obtaining a quick authentication password input by a user;

determining whether the quick authentication password input by the user is a quick authentication password of any user identity information corresponding to the current web page stored in a preset information list; wherein the preset information list is used to store user identity information corresponding to a web page containing a user identity authentication area, and quick authentication passwords corresponding to respective pieces of user identity information;

if the quick authentication password input by the user is a quick authentication password of any user identity information corresponding to the current web page, obtaining, from user identity information corresponding to the current web page stored in the preset information list, the user identity information corresponding to the quick authentication password input by the user;

sending a user identity authentication request to a server according the obtained user identity information, so as to cause the server to perform user identity authentication according to the obtained user identity information.

For specific processes of the above steps performed by the processor 702 and the steps performed by the processor 702 by executing the executable program code, references can be made to the description of the embodiments shown in FIGS. 1-6 of the present application, which are not described herein again.

The electronic equipment is present in a variety of forms, which comprises but is not limited to:

(1) a mobile communication equipment: this kind of equipment is characterized in its mobile communication capabilities and mainly aims to provide voice and data communication. This kind of terminal comprises: smartphones (e.g. iPhone), multimedia phones, functional phones and low-end phones and the like.

(2) an ultra-mobile personal computer equipment: this kind of equipment belongs to the category of personal computers, which has functions of computing and possessing and generally possesses mobile networking property. This kind of terminal comprises: PDA, MID and UMPC equipment and the like, for example an iPad.

(3) a portable entertainment equipment: this kind of equipment can display and play multimedia contents. This kind of equipment comprises: audio and video players (for example, iPods), handheld game consoles, e-books and smart toys and portable vehicle navigation equipment.

(4) a server: an equipment providing computing service, the server is consisted of a processor, a hard disk, a memory, system buss and the like. The server is similar to a general computer in architecture, but has a higher requirement in aspects such as processing ability, stability, reliability, security, scalability, manageability due to the need to provide high reliable services.

(5) other electronic device with data interaction function.

From the foregoing, it can be seen that in the solutions provided in this embodiment, when the current web page contains a user identity authentication area and it is determined that user identity authentication is to be performed through a quick authentication manner, the electronic equipment obtains a quick authentication password input by the user; and when it is determined that the obtained quick authentication password is a quick authentication password of any user identity information corresponding to the current web page stored in the preset information list, obtains the user input information corresponding to the quick authentication password input by the user from user identity information corresponding to the current web page stored in the preset information list; then sends a user identity authentication request to the server according to the obtained user identity information, so that the server performs user identity authentication according to the obtained user identity information. Compared with the prior art, after storing various user identity information in a preset information list, the user only need to remember and input a quick authentication password to implement user identity authentication, which simplifies the operation flow and facilitates the user's access to various websites, thereby improving the user experience.

An embodiment of the present application further provides an application program, which is used to perform the method for processing information provided by the above embodiments when being executed.

The above method for processing information includes:

determining whether a current web page contains a user identity authentication area;

if so, determining whether user identity authentication is to be performed through a quick authentication manner;

if the user identity authentication is to be performed through a quick authentication manner, obtaining a quick authentication password input by a user;

determining whether the quick authentication password input by the user is a quick authentication password of any user identity information corresponding to the current web page stored in a preset information list; wherein the preset information list is used to store user identity information corresponding to a web page containing a user identity authentication area, and quick authentication passwords corresponding to respective pieces of user identity information;

if the quick authentication password input by the user is a quick authentication password of any user identity information corresponding to the current web page, obtaining, from user identity information corresponding to the current web page stored in the preset information list, the user identity information corresponding to the quick authentication password input by the user;

sending a user identity authentication request to a server according to the obtained user identity information, so as to cause the server to perform user identity authentication according to the obtained user identity information.

From the foregoing, it can be seen that in the solutions provided in this embodiment, by performing the above application program, when the current web page contains the user identity authentication area and it is determined that user identity authentication is to be performed through a quick authentication manner, a quick authentication password input by the user is obtained; and when it is determined that the obtained quick authentication password is a quick authentication password of any user identity information corresponding to the current web page stored in the preset information list, the user input information corresponding to the quick authentication password input by the user is obtained from user identity information corresponding to the current web page stored in the preset information list; then a user identity authentication request is sent to the server according to the obtained user identity information, so that the server performs user identity authentication according to the obtained user identity information. Compared with the prior art, after storing various user identity information in a preset information list, the user only need to remember and input a quick authentication password to implement user identity authentication, which simplifies the operation flow and facilitates the user's access to various websites, thereby improving the user experience.

An embodiment of the present application further provides a storage medium, which is used to store an executable code, and the executable code is used to perform the method for processing information provided in the above embodiments.

The above method for processing information includes:

determining whether a current web page contains a user identity authentication area;

if so, determining whether user identity authentication is to be performed through a quick authentication manner;

if the user identity authentication is to be performed through a quick authentication manner, obtaining a quick authentication password input by a user;

determining whether the quick authentication password input by the user is a quick authentication password of any user identity information corresponding to the current web page stored in a preset information list; wherein the preset information list is used to store user identity information corresponding to a web page containing a user identity authentication area, and quick authentication passwords corresponding to respective pieces of user identity information;

if the quick authentication password input by the user is a quick authentication password of any user identity information corresponding to the current web page, obtaining, from user identity information corresponding to the current web page stored in the preset information list, the user identity information corresponding to the quick authentication password input by the user;

sending a user identity authentication request to a server according the obtained user identity information, so as to cause the server to perform user identity authentication according to the obtained user identity information.

From the foregoing, it can be seen that in the solutions provided in this embodiment, by executing the executable code stored in the above storage medium, when the current web page contains a user identity authentication area and it is determined that user identity authentication is to be performed through a quick authentication manner, a quick authentication password input by the user is obtained; and when it is determined that the obtained quick authentication password is a quick authentication password of any user identity information corresponding to the current web page stored in the preset information list, the user input information corresponding to the quick authentication password input by the user is obtained from user identity information corresponding to the current web page stored in the preset information list; then a user identity authentication request is sent to the server according to the obtained user identity information, so that the server performs user identity authentication according to the obtained user identity information. Compared with the prior art, after storing various user identity information in a preset information list, the user only need to remember and input a quick authentication password to implement user identity authentication, which simplifies the operation flow and facilitates the user's access to various websites, thereby improving the user experience.

The embodiments of an apparatus, an electronic equipment, an application program and a storage medium are described briefly since they are substantially similar to the embodiment of the method. Related contents can refer to the part that describes the embodiment of the method.

It should be noted that the relationship terms use here, such as “first,” “second,” and the like are only used to distinguish one entity or operation from another entity or operation, but do not necessarily require or imply that there is actual relationship or order between these entities or operations. Moreover, the terms “include,” “comprise,” or any variants thereof are intended to cover a non-exclusive inclusion, such that processes, methods, articles, or devices, including a series of elements, include not only those elements that have been listed, but also other elements that have not specifically been listed or the elements intrinsic to these processes, methods, articles, or devices. Without further limitations, elements limited by the wording “comprise(s) a/an . . . ” do not exclude additional identical elements in the processes, methods, articles, or devices, including the listed elements.

It can be understood by a person skilled in the art that all or a part of steps in the implementations of the above method can be accomplished by instructing related hardware through programs, the programs can be stored in a computer-readable storage medium, such as in ROM/RAM, a disk, an optical disk, and so on.

The embodiments described above are simply preferable embodiments of the present application, and are not intended to limit the scope of protection of the present application. Any modifications, alternatives, improvements, or the like within the spirit and principle of the present application shall be included within the scope of protection of the present application.

1. A method for processing information, comprising:
determining whether a current web page contains a user identity authentication area;
if the current web page contains a user identity authentication area, determining whether user identity authentication is to be performed through a quick authentication manner;
if the user identity authentication is to be performed through a quick authentication manner, obtaining a quick authentication password input by a user;
determining whether the quick authentication password input by the user is a quick authentication password of any user identity information corresponding to the current web page stored in a preset information list; wherein the preset information list is used to store user identity information corresponding to a web page containing a user identity authentication area, and quick authentication passwords corresponding to respective pieces of user identity information;
if the quick authentication password input by the user is a quick authentication password of any user identity information corresponding to the current web page, obtaining, from user identity information corresponding to the current web page stored in the preset information list, the user identity information corresponding to the quick authentication password input by the user;
sending a user identity authentication request to a server according to the obtained user identity information, so as to cause the server to perform user identity authentication according to the obtained user identity information.

2. The method according to claim 1, wherein determining whether user identity authentication is to be performed through a quick authentication manner comprises:
determining whether the preset information list contains user identity information corresponding to the current web page,
if not, it is determined that the user identity authentication is not to be performed through a quick authentication manner;
if yes, displaying selection information for the quick authentication manner; and
determining whether the user identity authentication is to be performed through a quick authentication manner according to the user's selection operation for the selection information;
or
wherein obtaining, from user identity information corresponding to the current web page stored in the preset information list, the user identity information corresponding to the quick authentication password input by the user comprises:
determining user identity information corresponding to the current web page stored in the preset information list;
obtaining, from the determined user identity information, the number of pieces of user identity information whose quick authentication password is consistent with the quick authentication password input by the user;
determining whether the obtained number is greater than 1;
if the obtained number is greater than 1, obtaining the user identity information corresponding to the quick authentication password input by the user according to the user's selection operation for the determined user identity information.

3. (canceled)

4. (canceled)

5. The method according to claim 1, when it is determined that the user identity authentication is not to be performed through a quick authentication manner, the method further comprises:
obtaining user identity information Inf_{UID} input by the user in the user identity authentication area of the current web page;
sending a user identity authentication request to a server according to the user identity information Inf_{UID};
when the user identity authentication is determined to be successful, determining whether a correspondence between the current web page and the user identity information Inf_{UID} is to be stored in the preset information list;
if a correspondence between the current web page and the user identity information Inf_{UID} is determined to be stored in the preset information list, storing the correspondence between the current web page and the user identity information Inf_{UID} in the preset information list according to a preset information storage rule.

6. The method according to claim 5, wherein storing the correspondence between the current web page and the user identity information Inf_{UID} in the preset information list according to a preset information storage rule comprises:
determining whether the preset information list contains a quick authentication password;
if yes, storing the correspondence between the current web page and the user identity information Inf_{UID} in the preset information list;
if not, obtaining a quick authentication password input by the user, and determining the obtained quick authentication password as a quick authentication password corresponding to the user identity information Inf_{UID}, and storing the correspondence between the current web page and the user identity information Inf_{UID} and the quick authentication password corresponding to the user identity information Inf_{UID} in the preset information list.

7. The method according to claim 6, wherein, before storing the correspondence between the current web page and the user identity information Inf_{UID} in the preset information list, the method further comprises:
obtaining an identity authentication password input by the user;
determining whether the identity authentication password is consistent with a quick authentication password existing in the preset information list;
if the identity authentication password is consistent with a quick authentication password existing in the preset information list, storing the correspondence between the current web page and the user identity information Inf_{UID} in the preset information list.

8. The method according to claim 5, wherein storing the correspondence between the current web page and the user identity information Inf_{UID} in the preset information list according to a preset information storage rule comprises:
obtaining a category to which the current web page belongs;
determining whether the preset information list contains a category quick authentication password corresponding to the category;
if yes, determining the category quick authentication password as a quick authentication password corresponding to the user identity information Inf_{UID};
if not, obtaining a category quick authentication password input by the user, and determining the obtained category quick authentication password as a quick authentication password corresponding to the user identity information Inf_{UID}, and storing the correspondence between the current web page and the user identity information Inf_{UID} and the quick authentication password corresponding to the user identity information Inf_{UID} in the preset information list.

9. The method according to claim 8, wherein determining whether the preset information list contains a category quick authentication password corresponding to the category comprises:
obtaining an identity authentication password input by the user;
determining whether the identity authentication password is consistent with a category quick authentication password stored in the preset information list according to the category;
if the identity authentication password is consistent with the category quick authentication password stored in the preset information list, determining that the preset information list contains a category quick authentication password corresponding to the category.

10. The method according to claim 5, wherein storing the correspondence between the current web page and the user identity information Inf_{UID} in the preset information list according to a preset information storage rule comprises:
obtaining a quick authentication password input by the user.
determining the quick authentication password input by the user as a quick authentication password corresponding to the user identity information Inf_{UID};
storing the correspondence between the current web page and the user identity information Inf_{UID} and the quick authentication password corresponding to the user identity information Inf_{UID} in the preset information list.

11. The method according to claim 5, wherein obtaining user identity information Inf_{UID} input by the user in the user identity authentication area of the current web page comprises:
calling a preset function to obtain each piece of character information input by the user in the user identity authentication area of the current web page, and obtain the user identity information Inf_{UID} according to the obtained character information; or
obtaining the user identity information Inf_{UID} according to a preset character recognition algorithm, after it is determined that the user has finished inputting the user identity information Inf_{UID} in the user identity authentication area of the current web page.

12. An apparatus for processing information, comprising:
a web page determination module, configured to determine whether a current web page contains a user identity authentication area;
an authentication manner determination module, configured to determine whether the user identity authentication is to be performed through a quick authentication manner when the determination result of the web page determination module is YES;
an authentication password obtaining module, configured to obtain a quick authentication password input by the user when the determination result of the authentication manner determination module is YES;
an authentication password determination module, configured to determine whether the quick authentication password input by the user is a quick authentication password of any user identity information corresponding to the current web page stored in a preset information list; wherein the preset information list is used to store user identity information corresponding to a web page containing a user identity authentication area, and quick authentication passwords corresponding to respective pieces of user identity information;
a first user identity information obtaining module, configured to obtain, from user identity information corresponding to the current web page stored in the preset information list, the user identity information corresponding to the quick authentication password input by the user when the determination result of the authentication password determination module is YES;
a first authentication request sending module, configured to send a user identity authentication request to a server according the obtained user identity information, so as to cause the server to perform user identity authentication according to the obtained user identity information.

13. The apparatus according to claim 12, wherein the authentication manner determination module is configured to determine whether the preset information list contains user identity information corresponding to the current web page, if not, it is determined that the user identity authentication is not to be performed through a quick authentication manner;
or wherein, the authentication manner determination module comprises:
a user identity information determination submodule, configured to determine whether the preset information list contains user identity information corresponding to the current web page;
a selection information displaying submodule, configured to display selection information for the quick authentication manner when the determination result of the user identity information determination submodule is yes;
an authentication manner determination submodule, configured to determine whether the user identity authentication is to be performed through a quick authentication manner according to the user's selection operation for the selection information;
or wherein, the first user identity information obtaining module comprises:
a user identity information determination submodule, configured to determine user identity information corresponding to the current web page stored in the preset information list;
an information quantity obtaining submodule, configure to obtain, from the determined user identity information, the number of pieces of user identity information whose quick authentication password is consistent with the quick authentication password input by the user;
an information quantity determination submodule, configured to determine whether the obtained number is greater than 1;
a user identity information obtaining submodule, configured to obtain the user identity information corresponding to the quick authentication password input by the user according to the user's selection operation for the determined user identity information, when the determination result of the information quantity determination submodule is YES.

14. (canceled)

15. (canceled)

16. The apparatus according to claim 12, wherein the apparatus further comprises:
a second user identity information obtaining module, configured to obtain user identity information Inf_{UID} input by the user in the user identity authentication area of the current web page, when it is determined that the user identity authentication is not to be performed through a quick authentication manner;
a second authentication request sending module, configured to send a user identity authentication request to a server according to the user identity information Inf_{UID};
a correspondence storage determination module, configured to, when the user identity authentication is determined to be successful, determine whether a correspondence between the current web page and the user identity information Inf_{UID} is to be stored in the preset information list;
a correspondence storage module, configured to store the correspondence between the current web page and the user identity information Inf_{UID} in the preset information list according to a preset information storage rule, when the determination result of the correspondence storage determination module is YES.

17. The apparatus according to claim 16, wherein the correspondence storage module comprises:
a first authentication password determination submodule, configured to determine whether the preset information list contains a quick authentication password;
a first correspondence storage module, configured to store the correspondence between the current web page and the user identity information Inf_{UID} in the preset information list, when the determination result of the first authentication password determination submodule is YES;
a second correspondence storage submodule, configured to, when the determination result of the first authentication password determination submodule is NO, obtain a quick authentication password input by the user, and determine the obtained quick authentication password as a quick authentication password corresponding to the user identity information Inf_{UID}, and store the correspondence between the current web page and the user identity information Inf_{UID} and the quick authentication password corresponding to the user identity information Inf_{UID} in the preset information list.

18. The apparatus according to claim 17, wherein the correspondence storage module further comprises:
a verification password obtaining submodule, configured to obtain an identity authentication password input by the user before the first correspondence storage submodule stores the correspondence;
a verification password determination submodule, configured to determine whether the identity authentication password is consistent with a quick authentication password existing in the preset information list, if the identity authentication password is consistent with a quick authentication password existing in the preset information list, the first correspondence storage submodule is triggered to store the correspondence.

19. The apparatus according to claim 16, wherein the correspondence storage module comprises:
a category obtaining sub-module, configured to obtain a category to which the current web page belongs;
a second authentication password determination submodule, configured to determine whether the preset information list contains a category quick authentication password corresponding to the category;
a third correspondence storage submodule, configured to determine the category quick authentication password as a quick authentication password corresponding to the user identity information Inf_{UID}, when the determination result of the second authentication password determination submodule is YES;
a fourth correspondence storage submodule, configured to, when the determination result of the second authentication password determination submodule is NO, obtain a category quick authentication password input by the user, and determine the obtained category quick authentication password as a quick authentication password corresponding to the user identity information Inf_{UID}, and store the correspondence between the current web page and the user identity information Inf_{UID} and the quick authentication password corresponding to the user identity information Inf_{UID} in the preset information list.

20. The apparatus according to claim 19, wherein the second authentication password determination submodule comprises:
a verification password obtaining unit, configured to obtain an identity authentication password input by the user;
a verification password determination unit, configured to determine whether the identity authentication password is consistent with a category quick authentication password stored in the preset information list according to the category; if the identity authentication password is consistent with a category quick authentication password stored in the preset information list, it is determined that the preset information list contains a category quick authentication password corresponding to the category.

21. The apparatus according to claim 16, wherein the correspondence storage module comprises:
a verification password obtaining module, configured to obtain a quick authentication password input by the user;
an authentication password determination submodule, configured to determine the quick authentication password input by the user as a quick authentication password corresponding to the user identity information Inf_{UID};
a fifth correspondence storage submodule, configured to store the correspondence between the current web page and the user identity information Inf_{UID} and the quick authentication password corresponding to the user identity information Inf_{UID}in the preset information list.

22. The apparatus according to claim 16, wherein the second user identity information obtaining module is configured to:
call a preset function to obtain each character information input by the user in the user identity authentication area of the current web page, and obtain the user identity information Inf_{UID} according to the obtained character information; or
obtain the user identity information Inf_{UID} according to a preset character recognition algorithm, after it is determined that the user has finished inputting the user identity information Inf_{UID} in the user identity authentication area of the current web page.

23. An electronic equipment, comprising: a housing, a processor, a memory, a circuit board, and a power circuit, wherein the circuit board is disposed inside the space enclosed by the housing, the processor and the memory are disposed on the circuit board; the power circuit is used to supply power to each circuit or device of the electronic equipment; the memory is used to store executable program code; the processor reads an executable program code stored in the memory to execute a program corresponding to the executable program code for performing the following steps:
determining whether a current web page contains a user identity authentication area;
if the current web page contains a user identity authentication area, determining whether user identity authentication is to be performed through a quick authentication manner;
if the user identity authentication is to be performed through a quick authentication manner, obtaining a quick authentication password input by a user;
determining whether the quick authentication password input by the user is a quick authentication password of any user identity information corresponding to the current web page stored in a preset information list; wherein the preset information list is used to store user identity information corresponding to a web page containing a user identity authentication area, and quick authentication passwords corresponding to respective pieces of user identity information;
if the quick authentication password input by the user is a quick authentication password of any user identity information corresponding to the current web page, obtaining, from user identity information corresponding to the current web page stored in the preset information list, the user identity information corresponding to the quick authentication password input by the user;
sending a user identity authentication request to a server according to the obtained user identity information, so as to cause the server to perform user identity authentication according to the obtained user identity information.

24. (canceled)

25. A non-transitory storage medium, wherein the storage medium is used to store an executable program code, the executable program code is configured to perform the method for processing information according to claim 1.
